(19) United States
(12) Patent Application Publication
(10) Pub. No.: US 2020/0123304 A1
(43) Pub. Date: Apr. 23, 2020

(54) CHEMICAL RESISTANCE IN POLYURETHANE DISPERSIONS BY NEUTRALIZATION WITH AMINE

(71) Applicant: COVESTRO LLC, Pittsburgh, PA (US)

(72) Inventors: Makoto Nakao, Pittsburgh, PA (US); Lyubov Gindin, Pittsburgh, PA (US); Stephanie Kane, Pittsburgh, PA (US); Natalee Jo-Ann Smith, Pittsburgh, PA (US)

(21) Appl. No.: 16/164,860

(22) Filed: Oct. 19, 2018

(51) Int. Cl. C08G 18/75; C08G 18/42; C08G 18/48; C08G 18/40; C08G 18/18; C08J 7/04; C09D 175/08; C09D 7/20; C09J 175/08; C09J 11/06; C09K 3/10

(52) U.S. Cl. CPC C08G 18/758; C08J 2475/08; C08G 18/485; C08G 18/4018; C08G 18/18; C08J 7/047; C09D 175/08; C09D 7/20; C09J 175/08; C09J 11/06; C09K 3/1021; C08G 2150/00; C08G 2170/00; C08J 2327/06; C08G 18/4225

(57) ABSTRACT

The present invention provides a partially neutralized aqueous polyurethane dispersion (PUD) containing an amorphous polyester, wherein the dispersion is from about 70% to about 90% neutralized with a sterically hindered amine. The partially neutralized aqueous polyurethane dispersion (PUD) may be used to provide coatings, adhesives, sealants, paints, primers, and topcoats having excellent chemical resistance to aggressive chemicals such as isopropanol.

### FIELD OF THE INVENTION

The present invention relates in general to polymers and, more specifically, to one component polyurethane dispersions which are neutralized with a sterically hindered amine to produce an enhanced resistance to aggressive chemicals such as isopropanol (propan-2-ol).

### BACKGROUND OF THE INVENTION

Commonly-assigned U.S. Ser. No. 15/667,139 filed on Aug. 2, 2017, U.S. Ser. No. 15/945,865 filed on Apr. 5, 2018, and U.S. Ser. No. 15/948,263 filed Apr. 9, 2018, all disclose one component aqueous polyurethane dispersions based on ortho-phthalic based polyester polyols which adhere well to vinyl and other substrates but still provide the necessary chemical, detergent, and humidity resistances and pencil hardness. Those polyurethane dispersions are used to provide coatings, adhesives, sealants, paints, primers, and topcoats which can satisfy the stringent standards of the American Architectural Manufacturers Association (AAMA) for window coatings. As those skilled in the art may be aware, some window and other substrate manufacturers go beyond the AAMA standards and require resistance to more aggressive cleaning chemicals such as isopropanol.

Therefore, a need exists in the art for an aqueous polyurethane dispersion (PUD) that can be used to produce coatings, adhesives, sealants, paints, primers, and topcoats having excellent chemical resistance with regard to aggressive chemicals such as isopropanol.

### SUMMARY OF THE INVENTION

Accordingly, the present invention reduces or eliminates problems inherent in the art by providing a partially neutralized aqueous polyurethane dispersion (PUD) containing an amorphous polyester. The dispersion is from about 70% to about 90% neutralized with a sterically hindered amine and can be used to provide coatings, adhesives, sealants, paints, primers, and topcoats having excellent chemical resistance to aggressive chemicals such as isopropanol.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

The aqueous polyurethane dispersions of the present invention are made as disclosed in commonly-assigned patent applications, U.S. Ser. No. 15/667,139 filed on Aug. 2, 2017, U.S. Ser. No. 15/945,865 filed on Apr. 5, 2018, and U.S. Ser. No. 15/948,263 filed Apr. 9, 2018, the entire contents of which are incorporated by reference herein, and are partially neutralized with a sterically hindered amine.

In one aspect, the present invention is directed to a partially neutralized aqueous polyurethane dispersion (PUD) comprising the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50% and wherein the aqueous polyurethane dispersion (PUD) is from 70% to 90% neutralized with a sterically hindered amine.

In another aspect, the present invention is directed to a coating comprising a partially neutralized aqueous polyurethane dispersion (PUD) comprising the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50% and wherein the aqueous polyurethane dispersion (PUD) is from 70% to 90% neutralized with a sterically hindered amine.

In yet another aspect, the present invention is directed to a paint comprising a partially neutralized aqueous polyurethane dispersion (PUD) comprising the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (v i) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50% and wherein the aqueous polyurethane dispersion (PUD) is from 70% to 90% neutralized with a sterically hindered amine.

In still another aspect, the present invention is directed to a method of increasing chemical resistance in an aqueous polyurethane dispersion (PUD), the method comprising partially neutralizing the aqueous polyurethane dispersion (PUD) with a sterically hindered amine, wherein the amount of neutralization is from 70% to 90%.

As used herein, the term “coating composition” refers to a mixture of chemical components that will cure and form a coating when applied to a substrate. As used herein, a “coating” means a layer of any substance spread over a surface.

The terms “adhesive” or “adhesive compound”, refer to any substance that can adhere or bond two items together. Implicit in the definition of an “adhesive composition” or “adhesive formulation” is the concept that the composition or formulation is a combination or mixture of more than one species, component or compound, which can include adhesive monomers, oligomers, and polymers along with other materials.

A “sealant composition” refers to a composition which may be applied to one or more surfaces to form a protective barrier, for example, to prevent ingress or egress of solid, liquid or gaseous material or alternatively to allow selective permeability through the barrier to gas and liquid. In particular, it may provide a seal between surfaces.

A “casting composition” refers to a mixture of liquid chemical components which is usually poured into a mold containing a hollow cavity of the desired shape, and then allowed to solidify.

A “composite” refers to a material made from two or more polymers, optionally containing other kinds of materials. A composite has different properties from those of the individual polymers/materials which make it up.

“Cured,” “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking. Suitable crosslinking additives include, but are not limited to, polyisocyanates, aziridines, and carbodiimides.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) is(are) not cured.

As used herein, the term “paint” refers to a substance used for decorating or protecting a surface, and is typically a mixture containing a solid pigment suspended in a liquid, that when applied to a surface dries to form a hard, protective coating.

As used herein, “primer” refers to a substance used as a preparatory coat on previously an unpainted or uncoated surface to prevent the absorption of subsequent layers of coating or paint.

As used herein, “topcoat” refers to a transparent or translucent coat applied over the underlying material as a sealer. In a paint system, the topcoat provides a seal over the intermediate coat(s) and the primer.

As used herein, “vinyl” means materials made by polymerizing an alkene group into a chain. Examples of vinyl compounds include, but are not limited to, polyvinylchloride, polystyrene, polyvinyl acetate, polyvinyl alcohol, and polyacrylonitrile.

As used herein, “polymer” encompasses prepolymers, oligomers and both homopolymers and copolymers; the prefix “poly” in this context referring to two or more. As used herein, “molecular weight”, when used in reference to a polymer, refers to the number average molecular weight (“Mₙ”), unless otherwise specified. As used herein, the Mₙ of a polymer containing functional groups, such as a polyol, can be calculated from the functional group number, such as hydroxyl number, which is determined by end-group analysis.

As used herein, “soft blocks” contain polyethers, polyesters and polycarbonates and “hard blocks” contain urethanes, urea groups, short chain amines, diols and diisocyanates. In some embodiments, the inventive compositions have a hard block content of greater than 50%. In certain other embodiments, the inventive compositions have a hard block content of 50% to 60%. In various non-limiting embodiments, the inventive compositions have a hard block content of 55% to 60%.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure thereof. As used herein, the term “cycloaliphatic” refers to organic compounds characterized by arrangement of carbon atoms in closed ring structures. Cycloaliphatic compounds do not contain aromatic rings as part of the molecular structure thereof. Therefore, cycloaliphatic compounds are a subset of aliphatic compounds. Therefore, the term “aliphatic” encompasses aliphatic compounds and cycloaliphatic compounds.

As used herein, “diisocyanate” refers to a compound containing two isocyanate groups. As used herein, “polyisocyanate” refers to a compound containing two or more isocyanate groups. Hence, diisocyanates are a subset of polyisocyanates.

As used herein, the term “dispersion” refers to a composition comprising a discontinuous phase distributed throughout a continuous phase. For example, “waterborne dispersion” and “aqueous dispersion” refer to compositions comprising particles or solutes distributed throughout liquid water. Waterborne dispersions and aqueous dispersions may also include one or more co-solvents in addition to the particles or solutes and water. As used herein, the term “dispersion” includes, for example, colloids, emulsions, suspensions, sols, solutions (i.e., molecular or ionic dispersions), and the like.

As used herein, the term “aqueous polyurethane dispersion” means a dispersion of polyurethane particles in a continuous phase comprising water.

As used herein, the term “polyurethane” refers to any polymer or oligomer comprising urethane (i.e., carbamate) groups, urea groups, or both. Thus, the term “polyurethane” as used herein refers collectively to polyurethanes, polyureas, and polymers containing both urethane and urea groups, unless otherwise indicated.

The terms “isopropyl alcohol”, “isopropanol” and the abbreviation “IPA” are used interchangeably throughout the instant Specification to refer to propan-2-ol.

Suitable polyisocyanates (i) include, but are not limited to, aromatic, araliphatic, aliphatic and cycloaliphatic polyisocyanates, such as, for example, 1,4-butylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, 1,4-cyclohexylene diisocyanate, 1,4-phenylene diisocyanate, 2,4- and/or 2,6-toluene diisocyanate or hydrogenated 2,4- and/or 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), (S)-alkyl 2,6-diisocyanato-hexanoates or (L)-alkyl 2,6-diisocyanatohexanoates.

Polyisocyanates having a functionality >2 can also be used if desired. Such polyisocyanates include modified diisocyanates having a uretdione, isocyanurate, urethane, allophanate, biuret, iminooxadiazine-dione and/or oxadiazinetrione structure, as well as unmodified polyisocyanates having more than 2 NCO groups per molecule, for example 4-isocyanatomethyl-1,8-octane diisocyanate (nonane triisocyanate) or triphenylmethane-4,4′,4″-triisocyanate.

In some embodiments of the present invention, polyisocyanates or polyisocyanate mixtures containing only aliphatically and/or cycloaliphatically bonded isocyanate groups are used that have a mean functionality of from 2 to 4, such as 2 to 2.6 or 2 to 2.4.

Polymeric polyols (ii) have a molecular weight Mn of from 400 to 8000 g/mol, such as 400 to 6000 g/mol or, in some cases, 500 to 3000 g/mol, 1000 to 3000 g/mol or 1500 to 3000 g/mol. In various non-limiting embodiments, these polymeric polyols have a hydroxyl number of from 20 to 400 mg KOH/g of substance, such as 20 to 300 mg KOH/g of substance, 20 to 200 mg KOH/g of substance or 20 to 100 mg KOH/g of substance. In certain embodiments, these polymeric polyols have a hydroxyl functionality of 1.5 to 6, such as 1.8 to 3 or 1.9 to 2.1. As will be appreciated, the Mₙ of a polymer containing functional groups, such as a polyol, can, as discussed earlier, be calculated from the functional group number, such as hydroxyl number, which is determined by end-group analysis. “Hydroxyl number”, as used herein, is determined according to DIN 53240.

Exemplary polymeric polyols (ii) include, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, polyester polycarbonate polyols, phenol/formaldehyde resins, on their own or in mixtures.

Suitable polyether polyols include, for example, the polyaddition products of the styrene oxides, of ethylene oxide, propylene oxide, tetrahydrofuran, butylene oxide, epichlorohydrin, as well as their mixed-addition and graft products, as well as the polyether polyols obtained by condensation of polyhydric alcohols or mixtures thereof and those obtained by alkoxylation of polyhydric alcohols, amines and amino alcohols.

Suitable polyether polyols often have a hydroxyl functionality of 1.5 to 6.0, such as 1.8 to 3.0, a hydroxyl number of 20 to 700 mg KOH/g solid, such as 20 to 100, 20 to 50 or, in some embodiments 20 to 40 mg KOH/g solid, and/or a Mn of 400 to 4000 g/mol, such as 100 to 4000 or 1000 to 3000 g/mol.

Exemplary polyester polyols are the polycondensation products of di- as well as optionally tri- and tetra-ols and di- as well as optionally tri- and tetra-carboxylic acids or hydroxycarboxylic acids or lactones. Instead of the free polycarboxylic acids it is also possible to use the corresponding polycarboxylic acid anhydrides or corresponding polycarboxylic acid esters of lower alcohols to prepare the polyesters. Examples of suitable diols are ethylene glycol, butylene glycol, diethylene glycol, triethylene glycol, polyalkylene glycols such as polyethylene glycol, further 1,2-propanediol, 1,3-propanediol, 1,3-butanediol, 1,4-butanediol, 1,6-hexanediol and isomers, 1,8-octanediol, neopentyl glycol, 1,4-bishydroxymethyl-cyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A, lactone-modified diols, or hydroxypivalic acid neopentyl glycol ester. In order to achieve a functionality>2, polyols having a functionality of 3 can optionally be used proportionately, for example trimethylolpropane, glycerol, erythritol, pentaerythritol, trimethylolbenzene or trishydroxyethyl isocyanurate.

Suitable dicarboxylic acids are, for example, phthalic acid, isophthalic acid, terephthalic acid, tetrahydrophthalic acid, hexahydro-phthalic acid, cyclohexane-dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, and/or 2,2-dimethylsuccinic acid. Anhydrides of those acids can likewise be used, where they exist. Thus, for the purposes of the present invention, anhydrides are included in the expression “acid”. Monocarboxylic acids, such as benzoic acid and hexanecarboxylic acid, can also be used, provided that the mean functionality of the polyol is ≥2. Saturated aliphatic or aromatic acids can be used, such as adipic acid or isophthalic acid. Trimellitic acid is a polycarboxylic acid which can also optionally be used.

Hydroxycarboxylic acids which can be used as reactants in the preparation of a polyester polyol having terminal hydroxyl groups are, for example, hydroxycaproic acid, hydroxybutyric acid, hydroxydecanoic acid, hydroxystearic acid and the like. Suitable lactones are, for example, ε-caprolactone, butyrolactone and their homologues.

In certain embodiments of the present invention, polymer polyol (ii) comprises or, in some cases, consists essentially of or consists of a polyester diol that is a reaction product of butanediol and one or more of neopentyl glycol, hexanediol, ethylene glycol, and diethylene glycol with adipic acid and one or more of phthalic acid and isophthalic acid, such as polyester polyols that are a reaction product of at least one of butanediol, neopentyl glycol, and hexanediol with at least one of adipic acid and phthalic acid.

Suitable polyester polyols, such as the foregoing polyester diols, often have a hydroxyl functionality of 1.5 to 6.0, such as 1.8 to 3.0, a hydroxyl number of 20 to 700 mg KOH/gram solid, such as 20 to 100, 20 to 80 or, in some cases 40 to 80 mg KOH/g solid, and/or a Mₙ of 500 to 3000 g/mol, such as 600 to 2500 g/mol.

Exemplary polycarbonate polyols are obtainable by reaction of carbonic acid derivatives, for example diphenyl carbonate, dimethyl carbonate or phosgene, with diols. Suitable diols include the diols mentioned earlier with respect to the preparation of polyester polyols. In some cases, the diol component contains from 40 wt. % to 100 wt. % 1,6-hexanediol and/or hexanediol derivatives, often containing ether or ester groups in addition to terminal OH groups, for example products which are obtained by reaction of one mole of hexanediol with at least one mole, preferably from one to two moles, of ε-caprolactone or by etherification of hexanediol with itself to form di- or tri-hexylene glycol. Polyether polycarbonate polyols can also be used.

The third component of the polyurethane dispersion (PUD) is a compound comprising at least one isocyanate-reactive group and an anionic group or potentially anionic group (iii). Exemplary such compounds are those which contain, for example, carboxylate, sulfonate, phosphonate groups or groups which can be converted into the above-mentioned groups by salt formation (potentially anionic groups), and which can be incorporated into the macromolecules by isocyanate-reactive groups, such as hydroxyl or amine groups, that are present.

Suitable anionic or potentially anionic compounds are, for example, mono- and di-hydroxycarboxylic acids, mono- and di-aminocarboxylic acids, mono- and di-hydroxysulfonic acids, mono- and di-aminosulfonic acids as well as mono- and di-hydroxyphosphonic acids or mono- and di-aminophosphonic acids and their salts, such as dimethylol-propionic acid, dimethylolbutyric acid, hydroxypivalic acid, N-(2-amino-ethyl)-β-alanine, 2-(2-amino-ethylamino)-ethanesulfonic acid, ethylene-diamine-propyl- or -butyl-sulfonic acid, 1,2- or 1,3-propylenediamine-3-ethylsulfonic acid, malic acid, citric acid, glycolic acid, lactic acid. In certain embodiments, the anionic or potentially anionic compounds have at least one of carboxy, carboxylate, and sulfonate groups and have a functionality of from 1.9 to 2.1, such as the salts of 2-(2-aminoethyl-amino)ethanesulfonic acid.

In certain embodiments, component (iii) is used in an amount of at least 0.1% by weight, such as at least 1%, or at least 3% by weight and/or no more than 10% by weight, such as no more than 7% by weight, based on the total weight of reactants used to make the polyurethane.

Amorphous polyesters (iv) are included in the inventive polyurethane dispersion (PUD) which have a glass transition temperature (T_{g}) as determined by differential scanning calorimetry (DSC) of less than −30° C. In various non-limiting embodiments, these polyesters have a molecular weight of from 300 to 3000. In certain embodiments, these polyesters have a molecular weight of approximately 1000. In some embodiments the amorphous polyester (iv) comprises an ortho-phthalic anhydride/1,6-hexane diol.

Component (vi) is a mono functional polyalkylene ether that contains at least one, in some cases one, hydroxy or amino group. In some embodiments, component (vi) comprises compounds of the formula:

H—Y′—X—Y—R

in which R is a monovalent hydrocarbon radical having 1 to 12 carbon atoms, such as an unsubstituted alkyl radical having 1 to 4 carbon atoms; X is a polyalkylene oxide chain having 5 to 90, such as 20 to 70 chain members, which may comprise at least 40%, such as at least 65%, ethylene oxide units and which in addition to ethylene oxide units may comprise propylene oxide, butylene oxide and/or styrene oxide units; and Y and Y′ are each independently oxygen or —NR′— in which R′ is H or R, in which R is defined above.

Mono functional polyalkylene ethers suitable for use in component (vi) may, in some cases, contain 7 to 55 ethylene oxide units per molecule, and can be obtained by alkoxylation of suitable starter molecules, such as, for example, saturated monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methyl-cyclohexanols or hydroxymethyl-cyclohexane, 3-ethyl-3-hydroxymethyloxetan or tetrahydrofurfuryl alcohol; diethylene glycol monoalkyl ethers, such as, for example, diethylene glycol monobutyl ether; unsaturated alcohols, such as allyl alcohol, 1,1-dimethyl-allyl alcohol or oleic alcohol; aromatic alcohols, such as phenol, the isomeric cresols or methoxyphenols; araliphatic alcohols, such as benzyl alcohol, anise alcohol or cinnamic alcohol; secondary monoamines, such as dimethylamine, diethylamine, dipropylamine, diisopropylamine, dibutyl-amine, bis-(2-ethylhexyl)-amine, N-methyl- and N-ethyl-cyclohexylamine or dicyclohexylamine; as well as heterocyclic secondary amines, such as morpholine, pyrrolidine, piperidine or 1H-pyrazole, including mixtures of two or more of any of the foregoing.

Alkylene oxides suitable for the alkoxylation reaction include, for example, ethylene oxide and propylene oxide, which can be used in the alkoxylation reaction in any desired sequence or alternatively in admixture. In some embodiments, component (vi) comprises a copolymer of ethylene oxide with propylene oxide that contains ethylene oxide in an amount of at least 40% by weight, such as at least 50% by weight, at least 60% by weight or at least 65% by weight and/or up to 90% by weight or up to 80% by weight, based on the total weight of ethylene oxide and propylene oxide. In certain embodiments, the Mₙ of such a copolymer is 300 g/mol to 6000 g/mol, such as 500 g/mol to 4000 g/mol, such as 1000 g/mol to 3000 g/mol.

In various non-limiting embodiments, component (vi) is used in an amount of at least 1% by weight, such as at least 5%, or at least 10% by weight or no more than 30% by weight, such as no more than 20% by weight, based on the total weight of reactants used to make the polyurethane.

Component (vii) comprises a polyol having a molecular weight of less than <400 grams/mol. Examples of such polyols include, without limitation, the diols mentioned earlier with respect to the preparation of polyester polyols. In some cases, the polyol having a molecular weight of less than <400 g/mol has up to 20 carbon atoms, such as is the case with, for example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxy-phenyl)propane), hydrogenated bisphenol A, (2,2-bis(4-hydroxycyclo-hexyl)propane), trimethylolpropane, glycerol, pentaerythritol and also any desired mixtures of two or more thereof. Also suitable are ester diols of the specified molecular weight range such as α-hydroxybutyl-ε-hydroxy-caproic acid ester, ω-hydroxyhexyl-γ-hydroxybutyric acid ester, β-hydroxy-ethyl adipate or bis(β-hydroxyethyl) terephthalate.

In certain embodiments, component (vii) is used in an amount of at least 1% by weight, such as at least 2%, or at least 3% by weight and/or no more than 20% by weight, such as no more than 10% or no more than 5% by weight, based on the total weight of reactants used to make the polyurethane.

Component (viii) is used for chain extension and includes di- or poly-amines as well as hydrazides, for example ethylenediamine, 1,2- and 1,3-diaminopropane, 1,4-diaminobutane, 1,6-diaminohexane, isophorone-diamine, isomer mixture of 2,2,4- and 2,4,4-trimethyl-hexamethylene-diamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic acid dihydrazide. Also suitable for use are compounds which contain active hydrogen of different reactivity towards NCO groups, such as compounds which contain, in addition to a primary amino group, also secondary amino groups or, in addition to an amino group (primary or secondary), also OH groups. Examples thereof are primary/secondary amines, such as 3-amino-1-methyl-aminopropane, 3-amino-1-ethylaminopropane, 3-amino-1-cyclohexylaminopropane, 3-amino-1-methylaminobutane, also alkanolamines such as N-aminoethylethanol-amine, ethanolamine, 3-aminopropanol or neopentanolamine.

In certain embodiments, component (viii) is used in an amount of at least 1% by weight, such as at least 3% or at least 5% by weight and no more than 10% by weight, such as no more than 8% or, in some cases, no more than 7% by weight, based on the total weight of reactants used to make the polyurethane.

In various non-limiting embodiments of the present invention, the aqueous polyurethane dispersion (PUD) has a glass transition temperature (T_{g}) as determined by differential scanning calorimetry (DSC) of 0° C. to 20° C. and a hard block content of greater than 50%. In certain embodiments, the hard block content is from 50% to 60% and in a preferred embodiment, the hard block content is from greater than 55% to 60%.

Any of a variety of processes can be used to prepare the aqueous polyurethane dispersion (PUD) of the present invention, such as the prepolymer mixing method, acetone method or melt dispersing method, each of which will be understood by a person skilled in the art of making aqueous polyurethane dispersions. For example, in some embodiments, the aqueous polyurethane dispersions of the present invention may be produced by the acetone method, such as is described, for example, in U.S. Patent Application Publication No. 2007/0167565 A1 at [0057]-[0073], the cited portion of which being incorporated herein by reference.

In certain embodiments, the resin solids content of the aqueous polyurethane dispersion (PUD) prepared by any of these methods is at least 20% by weight, such as at least 25% or at least 30% by weight or no more than 65% by weight, such as no more than 50% or no more than 45% by weight, based on the total weight of the dispersion.

Among the possible applications for the inventive aqueous polyurethane dispersion (PUD) is in or as a coating, paint, primer or topcoat for application on a frame of an architectural article, such as a vinyl door, door frame, window, window frame, window surrounds, window shutters, railing, gates, pillars, arbors, pergolas, trellises, gazebos, posts, fencing, cladding and siding, particularly those that are constructed of a material such as polyvinylchloride (PVC).

In various non-limiting embodiments, the aqueous polyurethane dispersion (PUD) of the present invention may produce a cured coating that, when used on a frame of an architectural article, such as a door or window. In certain other embodiments, the aqueous polyurethane dispersion (PUD) of the present invention may be applied to any of a variety of substrates including, but not limited to, wood; plastics such as polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polystyrene (PS), polyvinyl chloride (PVC), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymathic methacrylate (PMMA), polybenzimidazole (PBI), polyoxymethylene (POM); concrete; masonry; textiles; metals; ceramics; composites; and glass.

The present inventors have surprisingly found that controlling the neutralization levels in the aqueous polyurethane dispersions (PUDs) leads to improved chemical resistance in coatings, adhesives, sealants, paints, primers, and topcoats made from those dispersions. In various non-limiting embodiments, neutralization levels of between 50% and 100%, in other embodiments, between 70% and 90%, and in still other embodiments 70% to 80% are achieved by the adding a sterically hindered amine, such as diisopropylethylamine (DIPEA) or triethylamine (TEA) to the aqueous polyurethane dispersion (PUD). The lower portion of the neutralization range improves resistance to chemicals such as isopropanol in coatings, adhesives, sealants, paints, primers, and topcoats made from the neutralized aqueous polyurethane dispersions (PUDs). The inventors also surprisingly found that the boiling point of the neutralizing amine affects chemical resistance in the coatings, adhesives, sealants, paints, primers, and topcoats made from those neutralized aqueous polyurethane dispersions (PUDs) with amines having lower boiling points showing better results than those with higher boiling points.

The aqueous polyurethane dispersions (PUDs), coatings, adhesives, sealants, paints, primers, and topcoats of the present invention may further include any of a variety of additives such as defoamers, devolatilizers, thickeners, flow control additives, colorants (including pigments and dyes), surfactants, dispersants, and neutralizers as is known to those skilled in the art.

The aqueous polyurethane dispersions (PUDs), coatings, paints, primers, and topcoats of the present invention may be admixed and combined with the conventional paint-technology binders, auxiliaries and additives, selected from the group of pigments, dyes, matting agents, flow control additives, wetting additives, slip additives, pigments, including metallic effect pigments, fillers, nanoparticles, light stabilizing particles, anti-yellowing additives, thickeners, and additives for reducing the surface tension.

The aqueous polyurethane dispersions (PUDs), coatings, adhesives, paints, primers, topcoats, and sealants according to the invention can be applied to the substrate by the conventional techniques, such as, spraying, rolling, flooding, printing, knife-coating, pouring, brushing and dipping.

The aqueous polyurethane dispersions (PUDs), coatings, adhesives, paints, primers, topcoats, and sealants according to the invention have an increased resistance to aggressive chemicals such as isopropyl alcohol.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated.

| | |
|---|---|
| POLYOL A | ortho-phthalic anhydride/1,6-hexane diol, having a molecular weight of |
| | 1000, commercially available from Stepan Co. as STEPANPOL PC- |
| | 1028-115; |
| POLYOL B | a butyl-diglycol based PO/EO (15.6%/63.5%) monol capped with EO |
| | (20.9%) having a hydroxyl number of about 25 mg KOH/g, |
| | commercially available from Covestro as POLYETHER LB-25; |
| ISOCYANATE A | 4,4′-dicyclohexylmethane diisocyanate having an NCO group content |
| | of about 31.8% and a functionality of about 2, commercially available |
| | from Covestro as DESMODUR W; |
| SURFACTANT A | a nonionic wetting agent and molecular defoamer (75% active liquid in |
| | ethylene glycol) commercially available from Air Products as |
| | SURFYNOL 104H; |
| AMINE A | triethylamine (TEA), having a boiling point of 89.5° C., commercially |
| | available from Fisher Scientific; |
| AMINE B | diisopropylethylamine (DIPEA), having a boiling point of 127° C., |
| | commercially available from Aldrich; |
| ADDITIVE A | dimethylolpropionic acid (DMPA); |
| ADDITIVE B | neopentylglycol (NPG); |
| ADDITIVE C | a solution of a polyether modified siloxane, commercially available |
| | from BYK Chemie as BYK-346; |
| ADDITIVE D | an amino alcohol (2-amino-2-methyl-1-propanol) used for neutralizing |
| | acid-functional resins, commercially available from Angus Chemical as |
| | AMP-95; |
| SOLVENT A | n-methyl-2-pyrrolidone (NMP); |
| SOLVENT B | diethylene glycol monobutyl ether, commercially available from The |
| | Dow Chemical Co. (50% in tap water); |
| EXTENDER A | diethylenetriamine (DETA); |
| EXTENDER B | hydrazine hydrate, 64% (HyHy); and |
| EXTENDER C | ethylenediamine (EDA). |

Neutralized polyurethane dispersions were prepared from the above components as follows:

PUD A (100% Neutralized with AMINE A)

Neutralized polyurethane dispersion A was made by a prepolymer process involving charging the specified amounts of POLYOL A, POLYOL B, ADDITIVE A and ADDITIVE B to a reactor and mixing at a temperature of 70° C. SOLVENT A was charged to the reactor, mixed and heated to a temperature of 70° C. The specified amount of ISOCYANTE A was added to the vessel and the vessel observed for an exothermic reaction. When the exothermic reaction was observed, the vessel was maintained at 95° C. The mixture was sampled and assessed for percent NCO. The mixture was cooled to 80° C. and another sample removed and assessed for percent NCO. A mixture of SOLVENT A and AMINE A was charged to the reactor and mixed for 20 minutes. The resultant neutralized prepolymer was dispersed in the specified amount of water along with the specified amount of SURFACTANT A. EXTENDERS A, B and C were added dropwise and the mixture stirred for one hour while cooling to room temperature. The polyurethane dispersion was filtered through a 50 μm filter before use. The prepolymer dispersed easily. No grit was observed during filtration.

PUD B (90% Neutralized with AMINE A)

Neutralized polyurethane dispersion B was made by a prepolymer process involving charging the specified amounts of POLYOL A, POLYOL B, ADDITIVE A, ADDITIVE B and SOLVENT A to a reactor and mixing at a temperature of 65° C. The specified amount of ISOCYANTE A was added to the vessel and the vessel observed for an exothermic reaction. When the exothermic reaction was observed, the vessel was maintained at approximately 94° C. The mixture was sampled and assessed for percent NCO. A mixture of SOLVENT A and AMINE A was charged to the reactor and mixed for 20 minutes. The resultant neutralized prepolymer was dispersed in the specified amount of water along with the specified amount of SURFACTANT A. EXTENDERS A, B and C were added dropwise and the mixture stirred for one hour while cooling to room temperature. The polyurethane dispersion was filtered through a 50 μm filter before use. The prepolymer dispersed easily. No grit was observed during filtration.

PUD C (80% Neutralized with AMINE A)

Neutralized polyurethane dispersion C was made by a prepolymer process involving charging the specified amounts of POLYOL A, POLYOL B, ADDITIVE A, ADDITIVE B and SOLVENT A and heating to 75° C. The vessel was cooled to room temperature and left under nitrogen overnight. The next day the flask was heated to 75° C. and ISOCYANATE A was added and the vessel was cooled to 64.2° C. The vessel was heated and the temperature peaked at 96.2° C. The mixture was sampled and assessed for percent NCO. The temperature was increased to 94° C. Two more samples were assessed for percent NCO. AMINE A and SOLVENT A were added and the mixture was stirred for 20 minutes. The resultant neutralized prepolymer was dispersed in the specified amount of water along with the specified amount of SURFACTANT A. EXTENDERS A, B and C were added dropwise and the mixture stirred for one hour while cooling to room temperature. The polyurethane dispersion was filtered through a 50 μm filter before use. The prepolymer dispersed easily.

PUD D (70% Neutralized with AMINE A)

Neutralized polyurethane dispersion D was made by a prepolymer process involving charging the specified amounts of POLYOL A, POLYOL B, ADDITIVE A, ADDITIVE B and SOLVENT A and heating to 70° C. The specified amount of ISOCYANTE A was added to the vessel and the vessel observed for an exothermic reaction. The mixture was sampled and assessed for percent NCO. When the exothermic reaction was observed, the vessel was maintained at 95° C. The mixture was sampled and assessed twice for percent NCO. A mixture of SOLVENT A and AMINE A was charged to the reactor and mixed for 20 minutes. The resultant neutralized prepolymer was dispersed in the specified amount of water along with the specified amount of SURFACTANT A. EXTENDERS A, B and C were added dropwise and the mixture stirred for one hour while cooling to room temperature. The dispersion did not pass through a 50 μm filter before use.

PUD E (90% Neutralized with AMINE B)

Neutralized polyurethane dispersion E was made by a prepolymer process involving charging the specified amounts of POLYOL A, POLYOL B, ADDITIVE A, ADDITIVE B and SOLVENT A and heating to 65° C. The specified amount of ISOCYANTE A was added to the vessel and the vessel observed for an exothermic reaction. The mixture was sampled and assessed for percent NCO. When the exothermic reaction was observed, the vessel was maintained at 95° C. The mixture was sampled and assessed twice for percent NCO. A mixture of SOLVENT A and AMINE B was charged to the reactor and mixed for 20 minutes. The resultant neutralized prepolymer was dispersed in the specified amount of water along with the specified amount of SURFACTANT A. EXTENDERS A, B and C were added dropwise and the mixture stirred for one hour while cooling to room temperature.

Table I summarizes the compositions, the theoretical and the final properties of the neutralized polyurethane dispersions (PUDs) having four different neutralization levels (i.e., 100%, 90%, 80%, and 70%).

TABLE I

| | PUD A | PUD B | PUD C | PUD D | PUD E |
|---|---|---|---|---|---|
| COMPONENT | | | | | |
| POLYOL A | 13.29 | 13.31 | 13.66 | 13.66 | 13.30 |
| POLYOL B | 1.15 | 1.15 | 1.19 | 1.19 | 1.15 |
| ADDITIVE A | 1.27 | 1.27 | 1.30 | 1.30 | 1.26 |
| ADDITIVE B | 1.38 | 1.38 | 1.42 | 1.42 | 1.38 |
| AMINE A | 0.96 | 0.86 | 0.79 | 0.69 | |
| AMINE B | | | | | 1.10 |
| ISOCYANATE A | 15.82 | 15.83 | 16.25 | 16.26 | 15.83 |
| SOLVENT A | 7.00 | 7.01 | 7.00 | 7.00 | 7.00 |
| EXTENDER A | 0.43 | 0.43 | 0.44 | 0.44 | 0.43 |
| EXTENDER B | 0.43 | 0.43 | 0.44 | 0.44 | 0.43 |
| EXTENDER C | 0.39 | 0.39 | 0.40 | 0.40 | 0.39 |
| SURFACTANT A | 0.17 | 0.17 | 0.18 | 0.18 | 0.17 |
| Water, DI | 57.71 | 57.77 | 56.95 | 57.05 | 57.55 |
| Theoretical Properties | | | | | |
| (Calculated) | | | | | |
| % COOH | 1.25 | 1.25 | 1.25 | 1.25 | 1.25 |
| % Chain Ext. | 90.19 | 91.47 | 90.19 | 90.19 | 91.47 |
| % NCO | 5.04 | 4.97 | 5.06 | 5.06 | 4.97 |
| % Neutralization | 100.00 | 90.08 | 80.00 | 70.00 | 89.99 |
| % Solids | 34.00 | 34.03 | 34.94 | 34.94 | 34.02 |
| NCO:OH | 1.65 | | 1.65 | 1.65 | |
| NCO:OH/NH | 1.04 | 1.03 | 1.04 | 1.04 | 1.03 |
| Formulation Results | | | | | |
| (Final Properties) | | | | | |
| % Solids (Final) | 35.10 | 34.78 | 35.92 | 35.98 | 33.55 |
| Mean Particle Size (μm) | 0.07 | 0.07 | 0.08 | 22.27 | 0.07 |
| Particle Size 50% | 0.07 | 0.07 | 0.07 | 8.63 | 0.07 |
| Particle Size 75% | 0.08 | 0.08 | 0.08 | 18.59 | 0.08 |
| Particle Size 90% | 0.08 | 0.09 | 0.09 | 56.55 | 0.09 |
| Particle Size 95% | 0.09 | 0.09 | 0.10 | 106.89 | 0.09 |
| Particle Size 99% | 0.10 | 0.10 | 0.12 | 229.62 | 0.10 |
| Viscosity @25° C. (cps) | 133.00 | 33.70 | 32.50 | 45.00 | 29.20 |
| pH | 8.39 | 8.00 | 8.26 | 8.34 | 8.21 |

One-component, waterborne polyurethane coatings were formulated with each neutralized aqueous polyurethane dispersion (PUD) according to Table II. These coatings were applied to a vinyl substrate with the results summarized in Table III.

TABLE II

| | COATING | COATING | COATING | COATING |
|---|---|---|---|---|
| | A | B | C | D |
| PUD A | 94.87 | | | |
| PUD B | | 94.90 | | |
| PUD C | | | 94.76 | |
| PUD D | | | | 95.06 |
| ADDITIVE C | 0.47 | 0.47 | 0.47 | 0.48 |
| SOLVENT B | 4.66 | 4.62 | 4.77 | 4.47 |
| VOC | 2.05 | 2.06 | 2.02 | 2.11 |
| Volume Solids | 29.91 | 29.60 | 30.69 | 28.44 |

In Table III, the substrate was vinyl; the method application was draw down 6 mil wet; the drying condition was room temperature or 50° C. for 10 minutes+additional aging at ambient temperature; and the testing was done by a 70% IPA spot test for 30 minutes. As can be appreciated by reference to Table III, the aqueous polyurethane dispersions PUDs that were neutralized with a sterically hindered amine at a 70% and 80% level performed better (i.e., slightly softened and recovered) versus those at 90% and 100% neutralization levels (i.e., softened, became tacky, had slight or severe cracks). These results demonstrated the importance of controlling the level of neutralization of the aqueous polyurethane dispersion (PUD) in maximizing chemical resistance in resulting coatings.

A one component waterborne coating based on aqueous polyurethane dispersion C (PUD C) was formulated with varying amounts of ADDITIVE D. Those coatings were dried at either ambient temperature or 50° C. for 10 minutes. An IPA spot test (70% IPA spot test for 30 minutes) was carried out following an additional seven days at ambient temperature with the results summarized in Table IV. “TFW” in the table means total formulation weight. As can be appreciated by reference to Table IV, the addition of an amino alcohol to the neutralized aqueous polyurethane dispersion (PUD) was detrimental to the isopropanol resistance of the resulting coating.

TABLE III

| | | Room Temperature | | | 50° C. for 10 min + Room Temperature | | |
|---|---|---|---|---|---|---|---|
| | % | +1 day | +3 days | +7 days | +1 day | +3 days | +7 days |
| Coating | Neutralization | 70% IPA spot test (30 min) | | | | | |
| A | 100% | soften/tacky, | soften/tacky, | soften/tacky, | soften/tacky, | soften/tacky, | soften/tacky, |
| | | severe crack | severe crack | severe crack | severe crack | severe crack | severe crack |
| B | 90% | soften/tacky, | soften/tacky, | soften/tacky, | soften/tacky, | soften/tacky, | soften/tacky, |
| | | no crack | slightly crack | no crack | no crack | slightly crack | no crack |
| C | 80% | slightly | slightly soften/ | slightly soften/ | slightly | slightly soften/ | slightly soften/ |
| | | soften/ | recover | recover | soften/ | recover | recover |
| | | recover | | | recover | | |
| D | 70% | slightly | slightly soften/ | slightly soften/ | slightly | slightly soften/ | slightly soften/ |
| | | soften/ | recover | recover | soften/ | recover | recover |
| | | recover | | | recover | | |

TABLE IV

| | | Room Temperature | | | 50° C. for 10 min + Room Temperature | | |
|---|---|---|---|---|---|---|---|
| | ADDITIVE D on | +1 day | +3 days | +7 days | +1 day | +3 days | +7 day |
| Coating | TFW (% wt) | 70% IPA spot test (30 min) | | | | | |
| C | 0.0% | slightly | slightly | slightly | slightly | slightly soften/ | slightly soften/ |
| | | soften/ | soften/ | soften/ | soften/ | recover | recover |
| | | recover | recover | recover | recover | | |
| C | 0.3% | soften/tacky, | soften/tacky, | soften/tacky, | soften/tacky, | soften/tacky, | soften/tacky, |
| | | no crack | severe crack | no crack | no crack | severe crack | no crack |
| C | 0.6% | soften/tacky, | soften/tacky, | soften/tacky, | soften/tacky, | soften/tacky, | soften/tacky, |
| | | slightly crack | severe crack | no crack | no crack | severe crack | no crack |
| C | 0.9% | soften/tacky, | soften/tacky, | soften/tacky, | soften/tacky, | soften/tacky, | soften/tacky, |
| | | severe crack | severe crack | severe crack | severe crack | severe crack | severe crack |

Two aqueous polyurethane dispersions were prepared at the same amount of neutralization (i.e., 90%) with different neutralizing sterically hindered amines. Aqueous polyurethane dispersion B (PUD B) was prepared with AMINE A which has a boiling point of 89.5° C. and aqueous polyurethane dispersion E (PUD E) was prepared with AMINE B which has a boiling point of 127° C. A one component waterborne polyurethane coating was formulated from each of those dispersions and applied to a vinyl substrate. The coatings were dried at ambient temperature or 50° C. for 10 minutes. An IPA spot test (70% IPA spot test for 30 minutes) was carried out following an additional seven days at ambient temperature with the results summarized in Table V. As can be appreciated by reference to Table V, aqueous polyurethane dispersion B (PUD B) which was neutralized with the lower boiling point AMINE A showed better resistance on vinyl to isopropanol.

The effect of wet film thickness (4 mil (101.6 μm), 6 mil (152.4 μm), 8 mil (203.2 μm) and 10 mil (254 μm)) for a tinted neutralized aqueous polyurethane dispersion C (PUD C) was assessed and the results are summarized in Table VI. As can be appreciated by reference to Table VI, a wet film thickness of 6 mil (152.4 μm) or less produced acceptable results in the 70% IPA spot test.

TABLE V

| | | Room Temperature | | | 50° C. for 10 min + Room Temperature | | |
|---|---|---|---|---|---|---|---|
| | Neutralizing | +1 day | +3 days | +7 days | +1 day | +3 days | +7 days |
| PUD | amine | 70% IPA spot test (30 min) | | | | | |
| B | AMINE A | soften/tacky, | soften/tacky, | soften/tacky, | soften/tacky, | soften/tacky, | soften/tacky, |
| | | no crack | slightly crack | no crack | no crack | slightly crack | no crack |
| E | AMINE B | soften/tacky, | soften/tacky, | soften/tacky, | soften/tacky, | soften/tacky, | soften/tacky, |
| | | no crack | severe crack | slightly crack | no crack | severe crack | slightly crack |

TABLE VI

| | | 50° C. for 10 min + Room Temperature | |
|---|---|---|---|
| | Wet film thickness | +1 day | +7 days |
| PUD | spray | 70% IPA spot test (30 min) | |
| C | 4 mil (101.6 μm) | slightly soften/recover | slightly soften/ |
| | | | recover |
| C | 6 mil (152.4 μm) | slightly soften/recover | slightly soften/ |
| | | | recover |
| C | 8 mil (203.2 μm) | slightly soften/tiny | slightly soften/tiny |
| | | pinhole | pinhole |
| C | 10 mil (254 μm) | slightly soften/tiny | slightly soften/tiny |
| | | pinhole | pinhole |

An assessment of the presence or absence of an amine alcohol was made and the results presented in Table VII. Aqueous polyurethane dispersion C (PUD C, 80% neutralized) was used at 6 mil (152.4 μm) film thickness with and without ADDITIVE D. As can be appreciated by reference to Table VII, the aqueous polyurethane dispersion (PUD) sample without ADDITIVE D performed better in 70% IPA, 90% IPA and with AAMA window cleaner (5 wt. % DOWANOL, 5 wt. % propylene glycol, 35 wt. % isopropanol, 55 wt. % water) testing.

The detergent resistance of a 6 mil (152.4 μm) film made from aqueous polyurethane dispersion (PUD C, 80% neutralized) without ADDITIVE D was assessed and the results summarized in Table VIII. The detergent was 53 wt. % Na₄P₂O₇ (anhydrous), 19 wt. % Na₂SO₄ (anhydrous), 7 wt. % Na₂SiO₃ (anhydrous), Na₂CO₃ (anhydrous), 20 wt. % dodecylbenzenesulfonic acid, sodium salt, tech. 88%.

These results demonstrate that the neutralizing amine in the cured film affects the final properties, such as chemical (e.g., IPA) resistance. The volatility of the neutralizing amine also affects the final properties. The aqueous polyurethane dispersion (PUD) neutralized with a lower boiling point amine showed better results at the same drying conditions.

TABLE VII

| | | | 70% IPA | 90% IPA | AAMA window cleaner | |
|---|---|---|---|---|---|---|
| | | Wet film | Room Temperature | | | |
| PUD | ADDITIVE D | thickness | +1 day | +1 day | +3 days | +7 days |
| C | yes | 6 mil | soften/tacky, | | soften/tacky, | |
| | | | slightly crack | | severe crack | |
| C | no | 6 mil | slightly soften/ | slightly soften/ | slightly soften/ | slightly soften/ |
| | | | recover | recover | recover | recover |

TABLE VIII

| | | | Detergent resistance | | |
|---|---|---|---|---|---|
| | | | Room Temperature curing for 7 days | | |
| | | Wet film | | | Gloss |
| PUD | ADDITIVE D | thickness | Initial gloss | Final gloss | retention |
| C | no | 6 mil | 16.4 | 21.6 | 132% |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A partially neutralized aqueous polyurethane dispersion (PUD) comprising the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50% a nd wherein the aqueous polyurethane dispersion (PUD) is from 70% to 90% neutralized with a sterically hindered amine.

Clause 2. The partially neutralized aqueous polyurethane dispersion (PUD) according to Clause 1, wherein the amorphous polyester (iv) comprises ortho-phthalic anhydride.

Clause 3. The partially neutralized aqueous polyurethane dispersion (PUD) according to one of Clauses 1 and 2, wherein the dispersion has a hard block content of 50% to 60%.

Clause 4. The partially neutralized aqueous polyurethane dispersion (PUD) according to any one of Clauses 1 to 3, wherein the dispersion has a hard block content of greater than 55% to 60%.

Clause 5. The partially neutralized aqueous polyurethane dispersion (PUD) according to any one of Clauses 1 to 4, wherein the amorphous polyester (iv) has a molecular weight of 300 to 3000.

Clause 6. The partially neutralized aqueous polyurethane dispersion (PUD) according to any one of Clauses 1 to 5, wherein the amorphous polyester (iv) has a molecular weight of 1000.

Clause 7. The partially neutralized aqueous polyurethane dispersion (PUD) according to any one of Clauses 1 to 6, wherein the polyisocyanate (i) is selected from the group consisting of 1,6-hexamethylene diisocyanate (HDI), pentamethylene diisocyanate (PDI), isophorone diisocyanate (IPDI), 2,2,4- and 2,4,4-trimethyl-hexamethylene diisocyanate, isomeric bis-(4,4′-isocyanatocyclohexyl)methanes or mixtures thereof of any desired isomer content, 1,4-cyclohexylene diisocyanate, 1,4-phenylene diisocyanate, 2,4- and 2,6-toluene diisocyanate or hydrogenated 2,4- and 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), and (S)-alkyl 2,6-diisocyanato-hexanoates or (L)-alkyl 2,6-diisocyanatohexanoates.

Clause 8. The partially neutralized aqueous polyurethane dispersion (PUD) according to any one of Clauses 1 to 7, wherein the PUD contains n-methyl-2-pyrrolidone (NMP).

Clause 9. The partially neutralized aqueous polyurethane dispersion (PUD) according to any one of Clauses 1 to 8, wherein the aqueous polyurethane dispersion (PUD) is from 70% to 80% neutralized.

Clause 10. The partially neutralized aqueous polyurethane dispersion (PUD) according to any one of Clauses 1 to 9, wherein the aqueous polyurethane dispersion (PUD) is 80% neutralized.

Clause 11. The partially neutralized aqueous polyurethane dispersion (PUD) according to any one of Clauses 1 to 10, wherein the sterically hindered amine has a boiling point of less than 100° C.

Clause 12. The partially neutralized aqueous polyurethane dispersion (PUD) according to any one of Clauses 1 to 10, wherein the sterically hindered amine has a boiling point of from 90° C. to 130° C.

Clause 13. The partially neutralized aqueous polyurethane dispersion (PUD) according to any one of Clauses 1 to 12, wherein the partially neutralized aqueous polyurethane dispersion (PUD) has increased chemical resistance compared to a completely neutralized aqueous polyurethane dispersion (PUD).

Clause 14. The partially neutralized aqueous polyurethane dispersion (PUD) according to Clause 13, wherein the chemical is isopropanol.

Clause 15. One of a coating, an adhesive, a paint, a primer, a topcoat, and a sealant comprising the partially neutralized aqueous polyurethane dispersion (PUD) according to any one of Clauses 1 to 14.

Clause 16. A substrate having applied thereto the one of a coating, an adhesive, a paint, a primer, a topcoat, and a sealant according to Clause 15.

Clause 17. The substrate according to Clause 16 wherein the substrate is polyvinylchloride.

Clause 18. The substrate according to one of Clauses 16 and 17, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

Clause 19. The substrate according to any one of Clauses 16 to 18, wherein the substrate is selected from the group consisting of wood, polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polystyrene (PS), polyvinyl chloride (PVC), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), concrete, masonry, textiles, metals, ceramics, composites, and glass.

Clause 20. A coating comprising a partially neutralized aqueous polyurethane dispersion (PUD) comprising the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50% and wherein the aqueous polyurethane dispersion (PUD) is from 70% to 90% neutralized with a sterically hindered amine.

Clause 21. The coating according to Clause 20, wherein the amorphous polyester (iv) comprises ortho-phthalic anhydride.

Clause 22. The coating according to one of Clauses 20 and 21, wherein the dispersion has a hard block content of 50% to 60%.

Clause 23. The coating according to any one of Clauses 20 to 22, wherein the dispersion has a hard block content of greater than 55% to 60%.

Clause 24. The coating according to any one of Clauses 20 to 23, wherein the amorphous polyester (iv) has a molecular weight of 300 to 3000.

Clause 25. The coating according to any one of Clauses 20 to 24, wherein the amorphous polyester (iv) has a molecular weight of 1000.

Clause 26. The coating according to any one of Clauses 20 to 25, wherein the polyisocyanate (i) is selected from the group consisting of 1,6-hexamethylene diisocyanate (HDI), pentamethylene diisocyanate (PDI), isophorone diisocyanate (IPDI), 2,2,4- and 2,4,4-trimethyl-hexamethylene diisocyanate, isomeric bis-(4,4′-isocyanatocyclohexyl)methanes or mixtures thereof of any desired isomer content, 1,4-cyclohexylene diisocyanate, 1,4-phenylene diisocyanate, 2,4- and 2,6-toluene diisocyanate or hydrogenated 2,4- and 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), and (S)-alkyl 2,6-diisocyanato-hexanoates or (L)-alkyl 2,6-diisocyanatohexanoates.

Clause 27. The coating according to any one of Clauses 20 to 26, wherein the PUD contains n-methyl-2-pyrrolidone (NMP).

Clause 28. The coating according to any one of Clauses 20 to 27, wherein the aqueous polyurethane dispersion (PUD) is from 70% to 80% neutralized.

Clause 29. The coating according to any one of Clauses 20 to 28, wherein the aqueous polyurethane dispersion (PUD) is 80% neutralized.

Clause 30. The coating according to any one of Clauses 20 to 29, wherein the sterically hindered amine has a boiling point of less than 100° C.

Clause 31. The coating according to any one of Clauses 20 to 29, wherein the sterically hindered amine has a boiling point of from 90° C. to 130° C.

Clause 32. The coating according to any one of Clauses 20 to 31, wherein the coating has improved chemical resistance compare to a comparable coating having 100% neutralization of the aqueous polyurethane dispersion (PUD).

Clause 33. The coating according to Clause 32, wherein the chemical is isopropanol.

Clause 34. A substrate having applied thereto the coating according to any one of Clauses 20 to 33.

Clause 35. The substrate according to Clause 34 wherein the substrate is polyvinylchloride.

Clause 36. The substrate according to one of Clauses 34 and 35, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

Clause 37. The substrate according to any one of Clauses 34 to 36, wherein the substrate is selected from the group consisting of wood, polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polystyrene (PS), polyvinyl chloride (PVC), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), concrete, masonry, textiles, metals, ceramics, composites, and glass.

Clause 38. A paint comprising a partially neutralized aqueous polyurethane dispersion (PUD) comprising the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50% and wherein the aqueous polyurethane dispersion (PUD) is from 70% to 90% neutralized with a sterically hindered amine.

Clause 39. The paint according to Clause 38, wherein the amorphous polyester (iv) comprises ortho-phthalic anhydride.

Clause 40. The paint according to one of Clauses 38 and 39, wherein the dispersion has a hard block content of 50% to 60%.

Clause 41. The paint according to any one of Clauses 38 to 40, wherein the dispersion has a hard block content of greater than 55% to 60%.

Clause 42. The paint according to any one of Clauses 38 to 41, wherein the amorphous polyester (iv) has a molecular weight of 300 to 3000.

Clause 43. The paint according to any one of Clauses 38 to 42, wherein the amorphous polyester (iv) has a molecular weight of 1000.

Clause 44. The paint according to any one of Clauses 38 to 43, wherein the polyisocyanate (i) is selected from the group consisting of 1,6-hexamethylene diisocyanate (HDI), pentamethylene diisocyanate (PDI), isophorone diisocyanate (IPDI), 2,2,4- and 2,4,4-trimethyl-hexamethylene diisocyanate, isomeric bis-(4,4′-isocyanatocyclohexyl)methanes or mixtures thereof of any desired isomer content, 1,4-cyclohexylene diisocyanate, 1,4-phenylene diisocyanate, 2,4- and 2,6-toluene diisocyanate or hydrogenated 2,4- and 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), and (S)-alkyl 2,6-diisocyanato-hexanoates or (L)-alkyl 2,6-diisocyanatohexanoates.

Clause 45. The paint according to any one of Clauses 38 to 44, wherein the PUD contains n-methyl-2-pyrrolidone (NMP).

Clause 46. The paint according to any one of Clauses 38 to 45, wherein the aqueous polyurethane dispersion (PUD) is from 70% to 80% neutralized.

Clause 47. The paint according to any one of Clauses 38 to 45, wherein the aqueous polyurethane dispersion (PUD) is 80% neutralized.

Clause 48. The paint according to any one of Clauses 38 to 47, wherein the sterically hindered amine has a boiling point of less than 100° C.

Clause 49. The paint according to any one of Clauses 38 to 48, wherein the sterically hindered amine has a boiling point of from 90° C. to 130° C.

Clause 50. The paint according to any one of Clauses 38 to 49 further including one selected from the group consisting of binders, auxiliaries pigments, dyes, matting agents, flow control additives, wetting additives, slip additives, metallic effect pigments, fillers, nanoparticles, light stabilizing particles, anti-yellowing additives, thickeners, additives for reducing the surface tension, and combinations thereof.

Clause 51. The paint according to any one of Clauses 38 to 50, wherein the paint has improved chemical resistance compare to a comparable paint having 100% neutralization of the aqueous polyurethane dispersion (PUD).

Clause 52. The paint according to Clause 51, wherein the chemical is isopropanol.

Clause 53. A substrate having applied thereto the paint according to any one of Clauses 38 to 52.

Clause 54. The substrate according to Clause 53, wherein the substrate is polyvinylchloride.

Clause 55. The substrate according to one of Clauses 53 and 54, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

Clause 56. The substrate according to any one of Clauses 53 to 55, wherein the substrate is selected from the group consisting of wood, polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polystyrene (PS), polyvinyl chloride (PVC), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (FBI), polyoxymethylene (POM), concrete, masonry, textiles, metals, ceramics, composites, and glass.

Clause 57. A method of increasing chemical resistance in an aqueous polyurethane dispersion (PUD), the method comprising partially neutralizing the aqueous polyurethane dispersion (PUD) with a sterically hindered amine, wherein the amount of neutralization is from 70% to 90%.

Clause 58. The method according to Clause 57, wherein the aqueous polyurethane dispersion (PUD) comprises the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50%.

Clause 59. The method according to one of Clauses 57 and 58, wherein the amount of neutralization is from 80% to 90%.

Clause 60. The method according to any one of Clauses 57 to 59, wherein the amount of neutralization is 80%.

Clause 61. The method according to any one of Clauses 57 to 60, wherein the amine has a boiling point of less than 100° C.

Clause 62. The method according to any one of Clauses 57 to 60, wherein the amine has a boiling point of from 90° C. to 130° C.

Clause 63. The method according to any one of Clauses 57 to 62, wherein the chemical is isopropanol.

Clause 64. One of a coating, an adhesive, a paint, a primer, a topcoat, and a sealant comprising an aqueous polyurethane dispersion (PUD) neutralized according to any one of Clauses 57 to 63.

1. A partially neutralized aqueous polyurethane dispersion (PUD) comprising the reaction product of:
(i) a polyisocyanate;
(ii) a polymeric polyol having a number average molecular weight of 400 to 8,000 g/mol;
(iii) a compound comprising at least one isocyanate-reactive group and an anionic group or potentially anionic group;
(iv) an amorphous polyester having a glass transition temperature (Tg) as determined by differential scanning calorimetry (DSC) of less than −30° C.;
(v) water;
(vi) a mono functional polyalkylene ether;
(vii) a polyol having a molecular weight of less than <400 g/mol, and (viii) a polyamine or amino alcohol having a molecular weight of 32 to 400 g/mol,
wherein the aqueous polyurethane dispersion (PUD) has a glass transition temperature (Tg) as determined by differential scanning calorimetry (DSC) of 0° C. to 20° C. and a hard block content of greater than 50% and wherein the aqueous polyurethane dispersion (PUD) is from 70% to 90% neutralized with a sterically hindered amine.

2. The partially neutralized aqueous polyurethane dispersion (PUD) according to claim 1, wherein the amorphous polyester (iv) comprises ortho-phthalic anhydride.

3. The partially neutralized aqueous polyurethane dispersion (PUD) according to claim 1, wherein the dispersion has a hard block content of 50% to 60%.

4. The partially neutralized aqueous polyurethane dispersion (PUD) according to claim 1, wherein the dispersion has a hard block content of greater than 55% to 60%.

5. The partially neutralized aqueous polyurethane dispersion (PUD) according to claim 1, wherein the amorphous polyester (iv) has a molecular weight of 300 to 3000.

6. The partially neutralized aqueous polyurethane dispersion (PUD) according to claim 1, wherein the amorphous polyester (iv) has a molecular weight of 1000.

7. The partially neutralized aqueous polyurethane dispersion (PUD) according to claim 1, wherein the polyisocyanate (i) is selected from the group consisting of 1,6-hexamethylene diisocyanate (HDI), pentamethylene diisocyanate (PDI), isophorone diisocyanate (IPDI), 2,2,4- and 2,4,4-trimethyl-hexamethylene diisocyanate, isomeric bis-(4,4′-isocyanatocyclohexyl)methanes or mixtures thereof of any desired isomer content, 1,4-cyclohexylene diisocyanate, 1,4-phenylene diisocyanate, 2,4- and 2,6-toluene diisocyanate or hydrogenated 2,4- and 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), and (S)-alkyl 2,6-diisocyanato-hexanoates or (L)-alkyl 2,6-diisocyanatohexanoates.

8. The partially neutralized aqueous polyurethane dispersion (PUD) according to claim 1, wherein the PUD contains n-methyl-2-pyrrolidone (NMP).

9. The partially neutralized aqueous polyurethane dispersion (PUD) according to claim 1, wherein the aqueous polyurethane dispersion (PUD) is from about 70% to about 80% neutralized.

10. The partially neutralized aqueous polyurethane dispersion (PUD) according to claim 1, wherein the aqueous polyurethane dispersion (PUD) is 80% neutralized.

11. The partially neutralized aqueous polyurethane dispersion (PUD) according to claim 1, wherein the sterically hindered amine has a boiling point of less than 100° C.

12. The partially neutralized aqueous polyurethane dispersion (PUD) according to claim 1, wherein the sterically hindered amine has a boiling point of from 90° C. to 130° C.

13. The partially neutralized aqueous polyurethane dispersion (PUD) according to claim 1, wherein the sterically hindered amine is selected from the group consisting of diisopropylethylamine (DIPEA) and triethylamine (TEA).

14. The partially neutralized aqueous polyurethane dispersion (PUD) according to claim 1, wherein the partially neutralized aqueous polyurethane dispersion (PUD) has increased chemical resistance compared to a completely neutralized aqueous polyurethane dispersion (PUD).

15. The partially neutralized aqueous polyurethane dispersion (PUD) according to claim 14, wherein the chemical is isopropanol.

16. One of a coating, an adhesive, a paint, a primer, a topcoat, and a sealant comprising the partially neutralized aqueous polyurethane dispersion (PUD) according to claim 1.

17. A coating comprising the partially neutralized aqueous polyurethane dispersion (PUD) according to claim 1.

18. The coating according to claim 17, wherein the aqueous polyurethane dispersion (PUD) is from 80% to 90% neutralized.

19. The coating according to claim 17, wherein the sterically hindered amine has a boiling point of less than 100° C.

20. The coating according to claim 17, wherein the sterically hindered amine has a boiling point of from 90° C. to 130° C.

21. The coating according to claim 17, wherein the sterically hindered amine is selected from the group consisting of diisopropylethylamine (DIPEA) and triethylamine (TEA).

22. The coating according to claim 17, wherein the coating has improved chemical resistance compare to a comparable coating having 100% neutralization of the aqueous polyurethane dispersion (PUD).

23. The coating according to claim 22, wherein the chemical is isopropanol.

24. A substrate having applied thereto the coating according to claim 17.

25. The substrate according to claim 24, wherein the substrate is polyvinylchloride.

26. The substrate according to claim 24, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

27. The substrate according to claim 24, wherein the substrate is selected from the group consisting of wood, polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polystyrene (PS), polyvinyl chloride (PVC), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), concrete, masonry, textiles, metals, ceramics, composites, and glass.

28. A method of increasing chemical resistance in an aqueous polyurethane dispersion (PUD), the method comprising partially neutralizing the aqueous polyurethane dispersion (PUD) with a sterically hindered amine, wherein the amount of neutralization is from 70% to 90%.

29. The method according to claim 29, wherein the aqueous polyurethane dispersion (PUD) comprises the reaction product of: (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C.; (v) water; (vi) a mono functional polyalkylene ether; (vii) a polyol having a molecular weight of less than <400 g/mol, and (viii) a polyamine or amino alcohol having a molecular weight of 32 to 400 g/mol, wherein the aqueous polyurethane dispersion (PUD) has a glass transition temperature (Tg) as determined by differential scanning calorimetry (DSC) of 0° C. to 20° C. and a hard block content of greater than 50%.

30. The method according to claim 28, wherein the amount of neutralization is from 70% to 80%.

31. The method according to claim 28, wherein the sterically hindered amine has a boiling point of less than 100° C.

32. The method according to claim 28, wherein the sterically hindered amine has a boiling point of from 90° C. to 130° C.

33. The method according to claim 28, wherein the chemical is isopropanol.

34. The method according to claim 28, wherein the sterically hindered amine is selected from the group consisting of diisopropylethylamine (DIPEA) and triethylamine (TEA).
